(19) United States
(12) Patent Application Publication
(10) Pub. No.: US 2008/0304076 A1
(43) Pub. Date: Dec. 11, 2008

(54) SYSTEMS AND METHODS FOR PACKAGING AND MOUNTING READOUT AND LASER INTENSITY MONITOR SENSORS

(75) Inventors: Timothy A. Beckwith, Coon Rapids, MN (US); Steven P. Ecklund, St. Anthony, MN (US)

Correspondence Address: HONEYWELL INTERNATIONAL INC.;PATENT SERVICES AB-2B, 101 COLUMBIA ROAD, P.O. BOX 2245, MORRISTOWN, NJ, 07962-2245, US

(73) Assignee: HONEYWELL INTERNATIONAL INC., Morristown, NJ (US)

(21) Appl. No.: 11/761,083

(22) Filed: Jun. 11, 2007

(51) Int. Cl. G01B 9/02

(52) U.S. Cl. 356/480

(57) ABSTRACT

Methods and apparatus for applying sensors to a ring laser gyro. An example apparatus includes a housing having a cavity, a laser intensity monitor (LIM) sensor mechanically and electrically connected within the cavity of the housing, and a readout sensor mechanically and electrically connected within the cavity of the housing. The LIM sensor and readout sensor are connected within the housing based on predetermined light output properties of a sensor mirror of a ring laser gyro. When the readout sensor is properly aligned with the sensor mirror, then the LIM sensor is automatically aligned with the sensor mirror.

### BACKGROUND OF THE INVENTION

Currently there are two optical sensors used with ring laser gyros (RLG). One of the sensors is a readout sensor and the other is a laser intensity monitor (LIM) sensor. Each of these sensors is produced in its own package. The RLG produces two laser beams at its sensing mirror and each of these sensors must be individually attached and aligned at the sensing mirror. Attachment of both of these sensors is time consuming and thereby costly.

Therefore, there exists a need for improving the efficiency of manufacturing RLGs.

### SUMMARY OF THE INVENTION

The present invention provides methods and apparatus for applying sensors to a ring laser gyro. An example apparatus includes a housing having a cavity, a laser intensity monitor (LIM) sensor mechanically and electrically connected within the cavity of the housing, and a readout sensor mechanically and electrically connected within the cavity of the housing. The LIM sensor and readout sensor are connected within the housing based on predetermined light output properties of a sensor mirror of a ring laser gyro. When the readout sensor is properly aligned with the sensor mirror, then the LIM sensor is automatically aligned with the sensor mirror and output laser beam.

In one aspect of the invention, the housing is a ceramic case having embedded conductive paths.

In another aspect of the invention, the readout sensor includes two photo detectors and the LIM sensor includes one photo detector. The photo detectors are photodiodes.

### BRIEF DESCRIPTION OF THE DRAWINGS

Preferred and alternative embodiments of the present invention are described in detail below with reference to the following drawings:

FIG. 1 illustrates a cross-sectional view of a portion of a ring laser gyro with an attached laser intensity monitor sensor and readout sensor package formed in accordance with an embodiment of the present invention;

FIG. 2 illustrates a perspective view of an LIM and readout sensor package formed in accordance with an embodiment of the present invention; and

FIG. 3 illustrates a cross-sectional view of a portion of a ring laser gyro with an attached laser intensity monitor sensor and readout sensor package formed in accordance with an alternate embodiment of the present invention;

### DETAILED DESCRIPTION OF THE PREFERRED EMBODIMENT

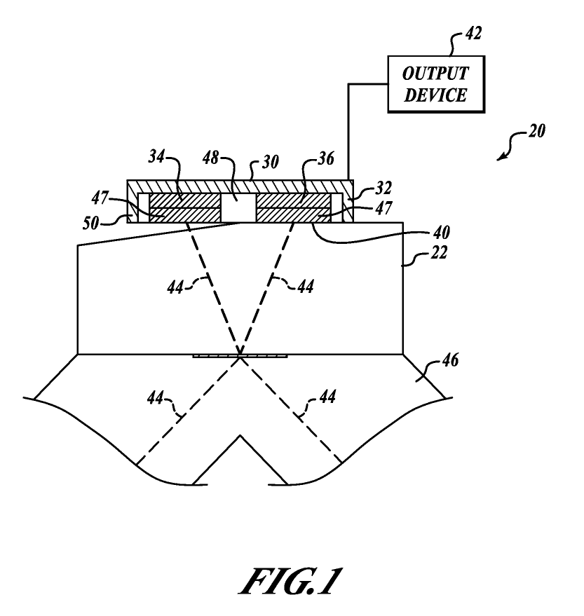

FIG. 1 illustrates a cross-sectional view of a portion of a ring laser gyro (RLG) 20 having a laser intensity monitor (LIM) and a readout sensor package 30 attached to a sensing mirror 22 that is attached to a laser block assembly (LBA) 46. In this example, the RLG 20 is a three-mirror RLG, however, other types of RLGs may be used.

The LIM and readout sensor package 30 includes a housing 32 that includes electrical leads (not shown). The package 30 includes an LIM sensor 34 and a readout sensor 36. The LIM sensor 34 and the readout sensor 36 are electrically connected to an output device 42 via the leads within the housing 32. An example of the output device 42 is an oscilloscope or other type of processing device.

The exact location of where light beams 44 within the LBA 46 will exit the mirror 22 is known. The size of the housing 32 and the location of the LIM sensor 34 and the readout sensor 36 within the housing 32 are determined according to the exit information of the light beams.

In order to align the package 30 with the mirror 22, first, a light (laser) source is activated within the LBA 46. Next, the package 30 is attached to the sensing mirror 22 using an optical adhesive 40. Before the adhesive 40 sets, the package 30 is rotated until a signal outputted by the readout sensor 36, as processed and presented on the output device 42, indicates optimal alignment. Once the package 30 has been optimally aligned, it is maintained in this position until the optical adhesive 40 sets. The LIM sensor 34 is attached within the housing 32 such that when the readout sensor 36 becomes aligned with the mirror 22 and light beams 44, the LIM sensor 34 becomes aligned. Thus, only one step is needed for aligning both sensors 34 and 36. For example, the sensors 34 and 36 are oriented relative to one another within the cavity of the housing 32 in such a way that when the readout sensor 36 is rotated to produce a lissajous pattern as determined at the output device 42, the LIM sensor 34 is automatically aligned. The lissajous pattern is a nominal 90° phase shift between the two sensing elements of the readout sensor 36. In one embodiment, the LIM sensor 34 is rectangular shaped and sized to allow for accurate reception of the light beam outputted by the mirror 22 to compensate for any errors that might occur in misalignment of the readout sensor 36.

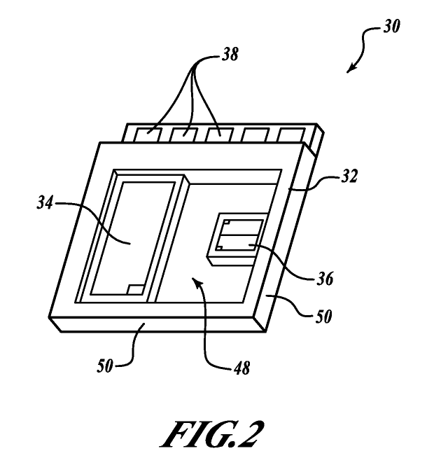

As shown in FIG. 2, the package 30 includes external electrical leads 38 that connect to the sensors 34 and 36 via traces (not shown) imbedded within the housing 32.

In one embodiment, the readout sensor 36 includes two sensing elements (photo detectors, such as photodiodes). The LIM sensor 34 includes a single photo detector (photodiode).

In one embodiment, the readout sensor 36 is a dual sensing element having chrome grid lines, such as that described in U.S. Pat. No. 4,871,253, which is hereby incorporated by reference. The photodetector sensors 34 and 36 are attached to the housing 32 using epoxy, solder, or other standard methods known to those skilled in the art of packaging semiconductor devices.

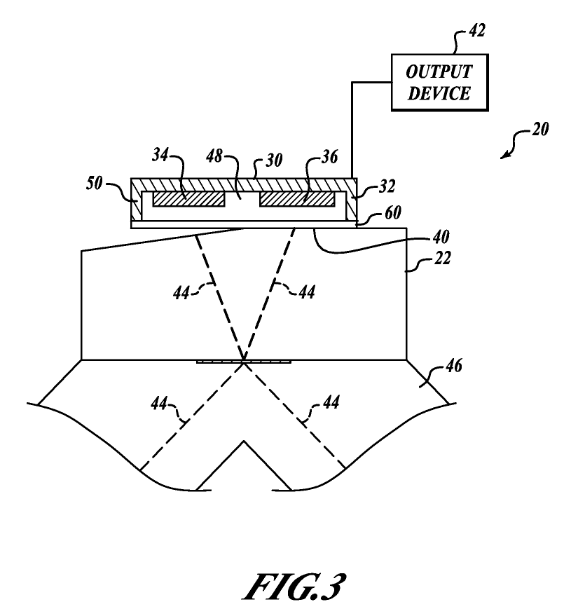

In one embodiment, the housing 32 is a ceramic case that includes conductive traces that connect leads (not shown) within to a cavity 48 to the leads 38. The cavity 48 receives the sensors 34 and 36 and is surrounded by a raised wall 50 that receives an optically clear window (60, FIG. 3) that is attached (e.g., epoxied) to the raised wall 50. An example of the optically clear window is a polished Pyrex™ having a glow-filter coating. In another embodiment, a glow-filter coating 47 (FIG. 1) is applied directly to either or both of the sensors 34 and 36.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A sensor package apparatus for use with a ring laser gyro, the apparatus comprising:
a housing including a cavity;
a laser intensity monitor (LIM) sensor mechanically and electrically connected within the cavity of the housing; and
a readout sensor mechanically and electrically connected within the cavity of the housing,
wherein the LIM sensor and readout sensor are connected within the housing based on predetermined light output properties of a sensor mirror of a ring laser gyro.

2. The apparatus of claim 1, wherein the housing is a ceramic case having embedded conductive paths.

3. The apparatus of claim 1, wherein the readout sensor includes two photo detectors and the LIM sensor includes one photo detector.

4. The apparatus of claim 3, wherein the photo detectors are photodiodes.

5. The apparatus of claim 1, wherein when the readout sensor is properly aligned with the sensor mirror, then the LIM sensor is automatically aligned with the sensor mirror.

6. A method for attaching optical sensors to a ring laser gyro, the method comprising:
electrically and mechanically connecting a readout sensor within a cavity of a housing; and
electrically and mechanically connecting a laser intensity monitor (LIM) sensor within the cavity of the housing based on predetermined light output properties of a sensor mirror of the ring laser gyro.

7. The method of claim 6, wherein the housing is a ceramic case having embedded conductive paths.

8. The method of claim 6, wherein the readout sensor includes two photo detectors and the LIM sensor includes one photo detector.

9. The method of claim 8, wherein the photo detectors are photodiodes.

10. The method of claim 8, further comprising aligning the housing with the sensor mirror so that the readout sensor is properly aligned.
